(19) United States
(12) Patent Application Publication
(10) Pub. No.: US 2013/0133593 A1
(43) Pub. Date: May 30, 2013

(54) ANIMAL LEASH

(71) Applicant: JOHN D. CHURCH, Garden City, GA (US)

(72) Inventor: JOHN D. CHURCH, Garden City, GA (US)

(21) Appl. No.: 13/687,362

(22) Filed: Nov. 28, 2012

Related U.S. Application Data
(60) Provisional application No. 61/629,822, filed on Nov. 29, 2011.
(60) Provisional application No. 61/631,996, filed on Jan. 17, 2012.
(60) Provisional application No. 61/632,720, filed on Jan. 30, 2012.
(60) Provisional application No. 61/633,230, filed on Feb. 7, 2012.

(51) Int. Cl. A01K 27/00

(52) U.S. Cl. CPC A01K 27/003
USPC 119/799

(57) ABSTRACT

An animal leash is provided. The animal leash such as, for example, for dogs, may include a handle portion, a rigid rod, and an attachment portion. The handle portion may be configured to be held by a hand of a user. The rigid rod may extend along a longitudinal axis and may have a proximal end and a distal end. The proximal end may be rigidly connected to the handle portion. An attachment portion may be coupled at or near the distal end of the rigid rod and configured to be removeably attached to a collar or harness on the animal.

### CROSS-REFERENCE TO RELATED APPLICATIONS

This application claims the priority benefit under 35 U.S.C. §119(e) of the following U.S. Provisional Patent Applications: U.S. Provisional Patent Application No. 61/629,822, filed Nov. 29, 2011, U.S. Provisional Patent Application No. 61/631,996, filed Jan. 17, 2012, U.S. Provisional Patent Application No. 61/632,720, filed Jan. 30, 2012, and U.S. Provisional Patent Application No. 61/633,230, filed Feb. 7, 2012. Each of the foregoing applications is hereby incorporated by reference in its entirety.

### BACKGROUND

1. Field of Invention

The invention relates generally to an animal leash and, more particularly, to a rigid animal leash for training and/or controlling an animal (e.g., a dog) releasably attached thereto.

2. Related Art

According to the American Pet Products Association 2011-2012 National Pet Owners Survey, there are approximately 78.2 million owned dogs in the United States. Thirty-nine percent of U.S. households own at least one dog. Millions of dog owners train and exercise their dogs every day by walking their dogs on a leash. Known leashes typically include a flexible fabric, rope, or cable arranged to be held in the owner's hand or hands at one end and connect to a collar or harness on the dog at the other end. Use of flexible fabric, rope, or cable, however, allows only limited control of the animal by pulling. What is needed is a device that provides three-dimensional control over the animal when walking and/or training the animal.

### SUMMARY

In accordance with an embodiment of the invention, an animal leash is provided. The animal leash (e.g., for dogs) may include a handle portion, a rigid rod, and an attachment portion. The handle portion may be configured to be held by a hand of a user. The rigid rod may extend along a longitudinal axis and may have a proximal end and a distal end. The proximal end may be rigidly connected to the handle portion. An attachment portion may be coupled at or near the distal end of the rigid rod and configured to be removeably attached to a collar or harness on the animal.

In accordance with an illustrative aspect of the invention, the attachment portion may be rotatably coupled to the distal end of the rigid rod.

In accordance with another illustrative aspect of the invention, the attachment portion may include an eye bolt rotatably coupled to the distal end of the rigid rod. The attachment portion may include a leash clip coupled to the eye bolt. The attachment portion may further include an intermediate connector coupled between the eye bolt and the leash clip. An end cap may be fixedly connected to the distal end of the rigid rod, wherein the eye bolt is rotatably coupled to the cap.

In accordance with another illustrative aspect of the invention, the handle portion and the rigid rod may be integrally formed from a rigid tubular member. The handle portion may include a section bent relative to the longitudinal axis of the rigid rod.

In accordance with another illustrative aspect of the invention, a safety tether may be connected to an end of the handle and configured to be worn around a wrist of the user during use. The safety tether may be connected to the end of the handle by an eye bolt. The eye bolt may be rotatably coupled to the end of the handle. An end cap may be fixedly connected to the end of the handle and the eye bolt may be rotatably coupled to the end cap.

In accordance with another illustrative aspect of the invention, the rigid rod may be extendable.

In accordance with another illustrative aspect of the invention, a length of the rigid rod may be between approximately 20 and 60 inches. For example, the length of the rigid rod may be between approximately 40 and 55 inches.

In accordance with another illustrative aspect of the invention, the rigid rod and the handle may be integrally formed from plastic or metal tubing. The plastic tubing may be, for example, polyvinylchloride. The metal tubing may be, for example, aluminum.

In accordance with another illustrative aspect of the invention, an extension assembly may be configured to be removeably coupled to the attachment portion to length the animal leash.

In accordance with another illustrative aspect of the invention, a yoke assembly may be configured to be removeably coupled to the attachment portion. The yoke assembly may include a transverse crosspiece having first and second ends. Attachment portions may be coupled at or near the ends of the transverse crosspiece and configured to be removeably attached to the collar or harness on multiple animals.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 is a perspective view of an animal leash according to an embodiment of the invention;

FIG. 1A is an illustrative perspective view of the animal leash of FIG. 1 in use;

FIG. 2 is an isolated front view of an attachment portion of the animal leash depicted in FIG. 1;

FIG. 3 is a an isolated side view of the attachment portion of the animal leash depicted in FIG. 1;

FIG. 4 is a perspective view of the animal leash of FIG. 1 including an extension assembly according to another embodiment of the invention;

FIG. 5 is a perspective view of the animal leash of FIG. 1 including an attachment assembly to allow control of multiple animals according to another embodiment of the invention; and

FIG. 6 is a perspective view of an animal leash having an extendible rigid body portion according to another embodiment of the invention.

### DETAILED DESCRIPTION

Some embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention.

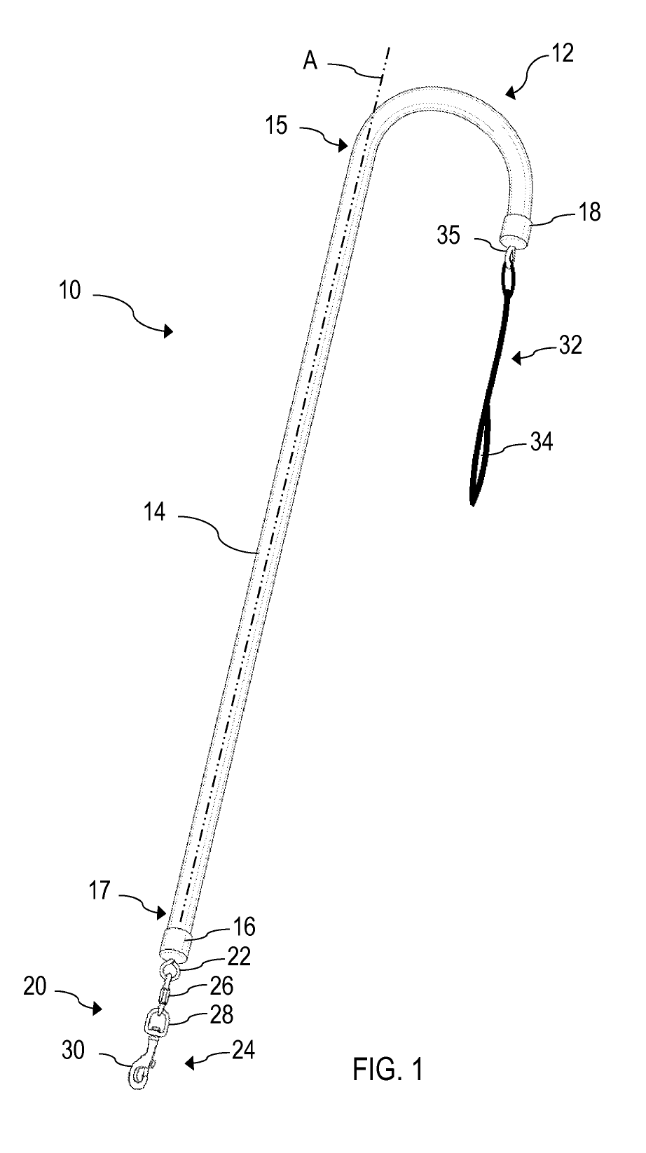

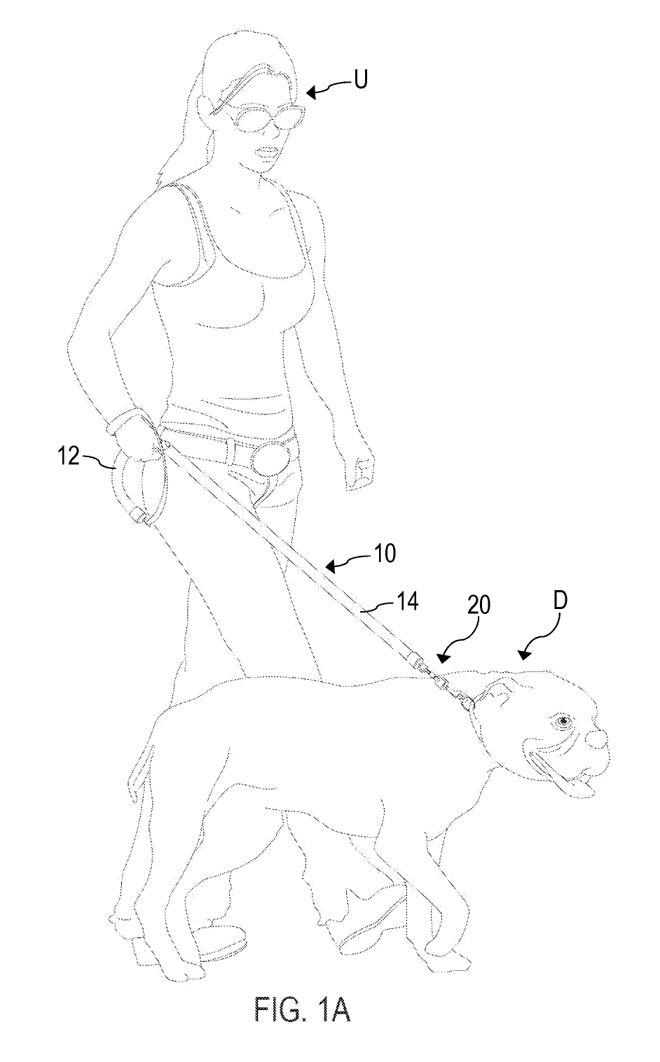

FIG. 1 is a perspective view of an animal leash 10 according to an embodiment of the invention. As shown in FIG. 1, the animal leash 10 includes a rigid handle portion 12, a rigid rod 14, and an animal attachment portion 20. The rigid rod 14 extends along a longitudinal axis A and includes a proximal end 15 and a distal end 17. The handle portion 12 may be rigidly connected to the proximal end 15 of the rigid rod 14 and configured to be gripped or held by a hand of the user. One or both of the handle portion 12 and the rigid rod 14 may be formed from a suitable material having a relatively high strength-to-weight ratio such as, for example, a plastic, a metal, or a composite material including, for example, polyvinylchloride (PVC) or aluminum. According to an embodiment, an overall length of the rigid rod 14 and handle portion 12 as measured along axis A may be between approximately 20 inches and 60 inches. According to an embodiment, an overall length of the rigid rod 14 and handle portion 12 as measured along axis A may be between approximately 40 inches and 55 inches. In some embodiments, such as for example but not limited to, use of leash 10 as a special law enforcement/military K9 training device, or for special needs dogs (e.g., seeing eye dogs), the length of the rigid rod 14 and handle portion 12 as measured along axis A may be approximately 20 inches. The length of the animal leash 10 may be fixed or adjustable, for example, as set forth in further detail below.

The handle portion 12 and the rigid rod 14 may be integrally formed, for example as shown in FIG. 1, by bending the proximal end 15 of the rigid rod 14 at an angle relative to the longitudinal axis A. Alternatively, the handle portion 12 and the rigid rod 14 may be separately manufactured and rigidly coupled together by known mechanical connections including, for example, welding, adhesives, fasteners, brackets, gussets, friction fit, snap fit, a threaded connection, and the like. The handle portion 12 may be formed having a radius of curvature as shown in FIG. 1 or the handle portion 12 may be a substantially straight or slightly curved portion relative to the longitudinal axis A. The rigid connection between the handle portion 12 and the rigid rod 14 may be substantially stiff and unyielding so that the handle portion 12 and the rigid rod 14 are firmly fixed or set relative to one another.

As shown in FIG. 1, an end cap 16 may be coupled to the distal end 17 of the rigid rod 12. Another end cap 18 may be coupled to an end of the handle portion 12. The end caps 16, 18 may be permanently or removeably attached to the rigid rod 12 and handle portion 12 by, for example, welding, adhesives, fasteners, brackets, gussets, friction fit, snap fit, a threaded connection, and the like. The end caps 16, 18 may be formed from a suitable material having a relatively high strength-to-weight ratio such as, for example, a plastic or a metal such as, for example but not limited to, polyvinylchloride (PVC) or aluminum or a composite material.

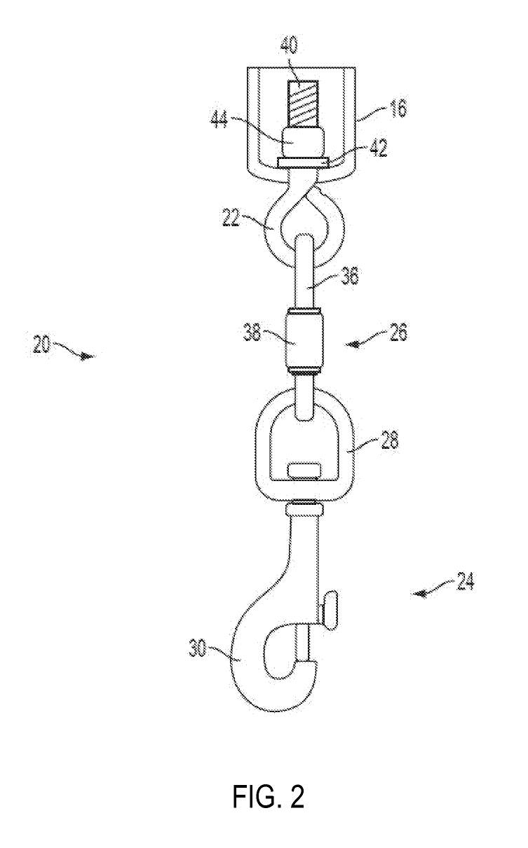

The animal leash 10 may include an attachment portion 20 connected to the distal end 17 of the rigid rod 14. The attachment portion 20 may be, for example, rotatably coupled to the end cap 16 or, alternatively, directly to the distal end 17 of the rigid rod 14. The attachment portion 20 may include a swivel connection element 22 rotatably connected to the end cap 16 as discussed in further detail below with reference to FIG. 2. Swivel connection element 22 may include, for example but not limited to, an eye bolt. An intermediate connector 26 may couple the swivel connection element 22 to a leash clip member 24. Alternatively, the leash clip member 24 may be directly coupled to the swivel connection element 22 without an intermediate member. The leash clip member 24 may be, for example, a traditional leash clip mechanism configured to be releasably attached to a collar or harness of an animal (e.g., a dog). End cap 18 on handle portion 12 may also include a swivel connection element 35 rotatably connected to the end cap 18 which is the same as or similar to swivel connection element 22. A tether device 32 in the form of, for example, a flexible fabric, rope, or cable element may be attached to swivel connection element 35 and may include a looped end 34 for being received over the hand and wrist of a user as a safety mechanism in the event the user loses his or her grip on handle portion 12.

As shown in the illustrated embodiment of FIG. 1, animal leash 10 may include a continuous rigid portion that extends between an animal and a user. The rigid portion, as shown, may extend continuously from the distal end 17 (animal end) along rod 14 and handle portion 12 to be gripped by the user. The continuous rigid portion may provide a stiff and/or unyielding extension between the animal and the user, such that the user has three-dimensional control over the animal as discussed in further detail herein. In the embodiment depicted in FIG. 1, both the handle portion 12 and the rod 14 are rigid along the entire length thereof. As shown in FIG. 1, handle portion 12 may extend at an angle relative to the longitudinal axis A of rod 14 so as to provide the user with added control. As such, the user may control the animal by movement of handle portion 12 in various directions, as discussed in further detail herein, which movement is translated through rod 14 to the distal end 17 thereof and, ultimately to the animal connected to the attachment portion 20. Animal leash 10 of FIG. 1 shows a continuously rigid portion, including rod 14 and handle portion 12, and which has substantially the same rigidity or stiffness along the entire length. In alternative embodiments, animal leash 10 may have varying degrees of rigidity along the length thereof in accordance with principles of the invention.

FIG. 1A depicts an illustrative perspective view of the animal leash 10 of FIG. 1 in use. A user U grips the handle portion 12 with his or her hand. The attachment portion 20 is shown attached to the collar of dog D. The rigid rod 14 extends between the handle portion 12 and the attachment portion 20. The animal leash 10 may provide the user U with three-dimensional control of dog D while walking and/or training dog D. For example, the rigidity of the handle portion 12, the rigid rod 14, and the rigid connection therebetween, enables the user U to substantially control movement of the dog D toward and away from the user U, side-to-side, as well as up-and-down. In this way, animal leash 10 can, for example, be used as a training device to teach puppies and/or full grown dogs not to jump or misbehave during walking and/or training. If, for example, the dog D attempts to jump up on user U or on a bystander, user U can easily prevent such movement due to the stiffness of the handle portion 12, the rigid rod 14, and the rigid connection therebetween. As shown in FIGS. 1 and 1A, for example, rigid handle portion 12 of the animal leash 10 may be curved and rigid rod 14 may be substantially straight, whereby the user, gripping handle portion 12, is provided with control over the distal end 17 of the rod 14 and, hence, the dog D.

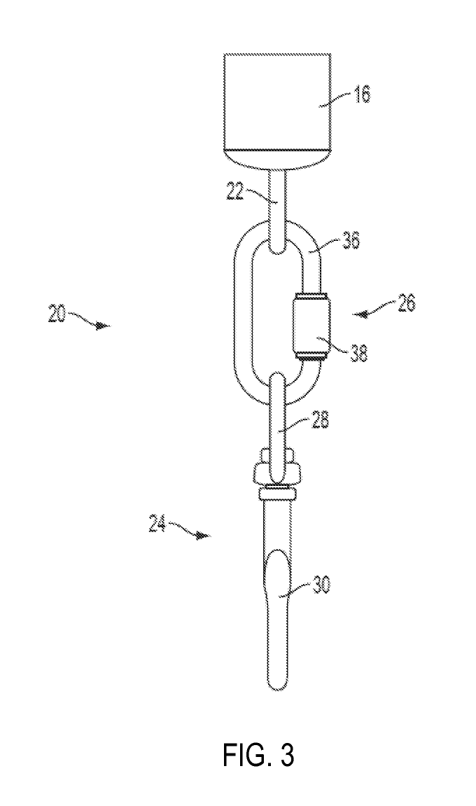

FIG. 2 is an isolated front view of the attachment portion 20 of the animal leash 10 depicted in FIG. 1. FIG. 3 is an isolated side view of the attachment portion 20 of the animal leash 10 depicted in FIG. 1. Attachment portion 20 may include swivel connection element 22, intermediate connector 26, and leash clip member 24. The swivel connection element 22 in FIGS. 2 and 3 is rotatably coupled to end cap 16. End cap 16 is shown in cross-section to allow viewing of attachment of swivel connection element 22. The swivel connection element 22 is depicted in this embodiment as an eye bolt but one of ordinary skill will recognize that any connection or fastener allowing rotation will suffice. Eye bolt 22 may include a threaded end 40 extending through a central hole in end cap 16. A washer 42 and a locking nut 44 (e.g., a nylon locking nut) may be coupled to the threaded end 40 of the eye bolt 22 to allow the eye bolt 22 to rotate within end cap 16. Intermediate connector 26 may include a ring portion 36 moveably coupled to the eye bolt 22 and a connection portion 28 of leash clip member 24. Intermediate connector 26 may also include a threaded sleeve 38 arranged to selectively close a gap in ring portion 36. The leash clip member 24 connection portion 28 may be rotatably coupled to latch body portion 30. Latch body portion 30 may include a spring-biased detent for releaseably coupling the leash clip member to a collar or harness of the animal as will be apparent to those of ordinary skill in the art.

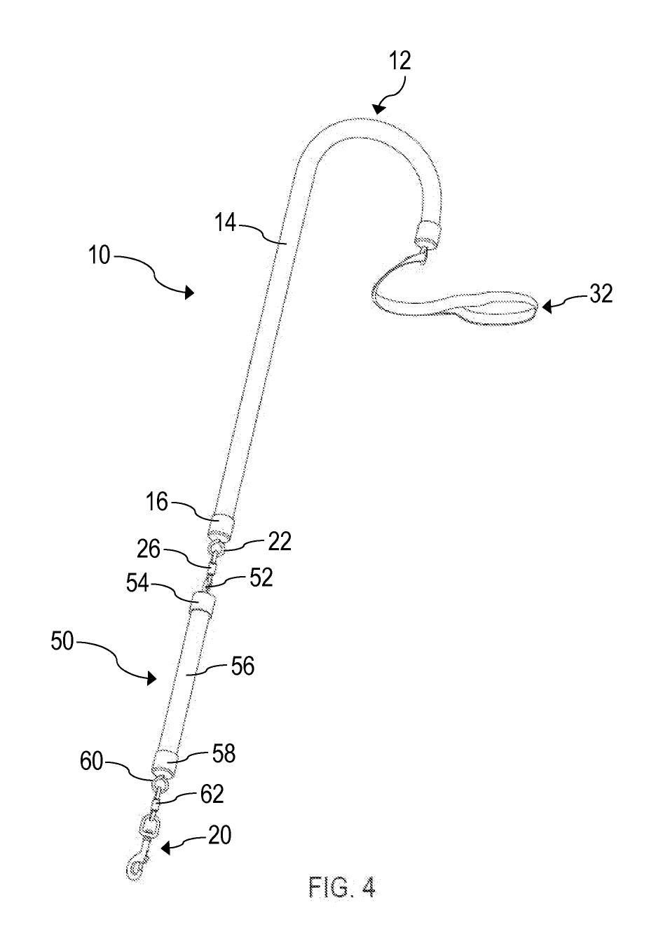

FIG. 4 is a perspective view of the animal leash 10 of FIG. 1 including an extension assembly 50 according to another embodiment of the invention. As shown in FIG. 4, the animal leash 10 of FIG. 1 may include an extension assembly 50 to selectively extend the length of the leash 10 and/or to provide some additional range of motion at the distal end of the leash 10. The distal end 17 of the rigid rod 14 may include end cap 16, swivel connection element 22, and intermediate connector 26. The extension assembly 50 may include a swivel connection element 52 connected to the intermediate connector 26 and to another end cap 54 at one end of rigid extension body 56. At the other end of rigid extension body 56 another end cap 58 may be provided. The rigid extension body 56 may be formed from a suitable material having a relatively high strength-to-weight ratio such as, for example, a plastic, a metal, or a composite material including, for example, polyvinylchloride (PVC) or aluminum. Rotatably coupled to end cap 58 is attachment portion 20, including swivel connection element 60, intermediate connector 62, and a leash clip member 24 as substantially described above with reference to FIGS. 2 and 3.

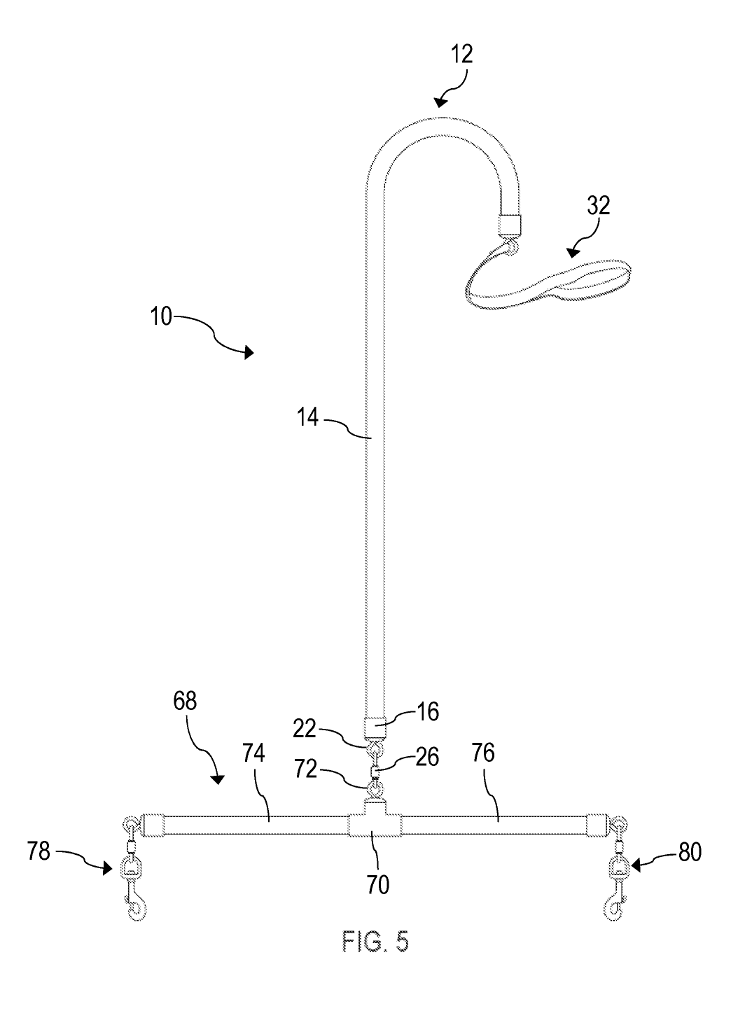

FIG. 5 is a perspective view of the animal leash 10 of FIG. 1 including an attachment assembly 68 to allow control of multiple animals according to another embodiment of the invention. FIG. 5 shows the distal end 17 of rigid rod 14 including end cap 16. Swivel connection element 22 is rotatably coupled to end cap 16. Intermediate connector 26 couples the swivel connection element 22 to another swivel connection element 72 rotatably coupled to a T-connector 70 of the attachment assembly 68. Branching off in opposite directions from the T-connector 70 are rigid bodies 74, 76, which may be, for example, rods or tubes. One or both of the T-connector 70 and the rigid bodies 74, 76 may be formed from a suitable material having a relatively high strength-to-weight ratio such as, for example, a plastic, a metal, or a composite material including, for example, polyvinylchloride (PVC) or aluminum. Attachment portions 78, 80, each of which may be constructed substantially similar to attachment portion 20 described above, are connected at the outer ends of the rigid bodies 74, 76, respectively, for releasable attachment to multiple animals. In this way, a user U may use animal leash 10, for example, to walk and/or train multiple dogs.

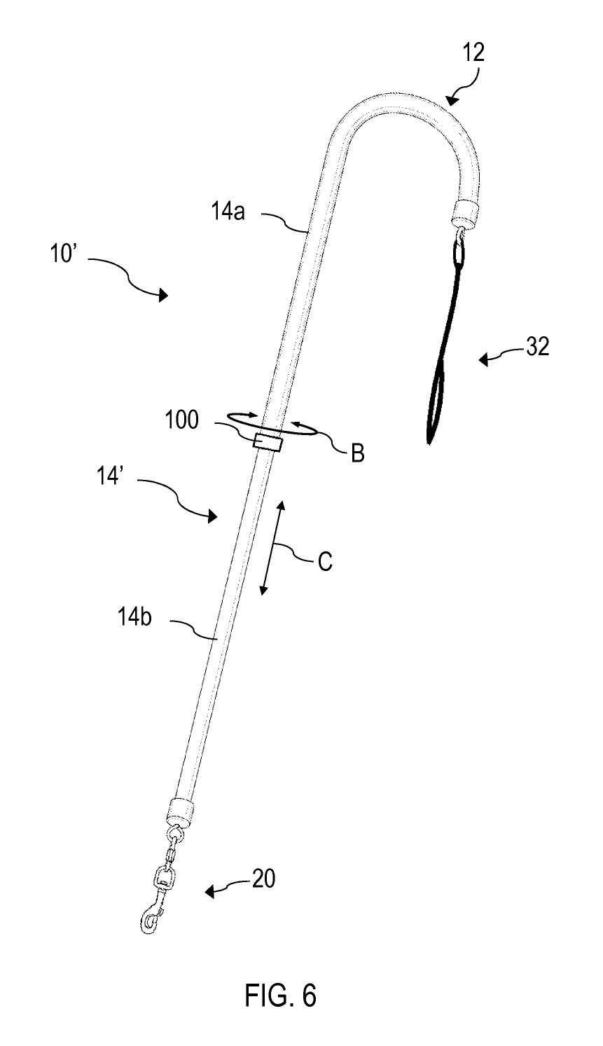

FIG. 6 is a perspective view of an animal leash 10′ having an extendible rigid body portion 14′ according to another embodiment of the invention. Animal leash 10′ is substantially the same as animal leash 10 described above with reference to FIG. 1 except that body portion 14′ is constructed as a telescoping tubular structure in which a first portion 14a and a second portion 14b are arranged to telescope with respect to one another in either direction as shown by arrow C. A locking mechanism 100 may be provided and may include, for example, a rotatable friction lock which can be rotated by user U in either direction as shown by arrow B to selectively lock and unlock portions 14a, 14b with respect to one another. This may allow the user U to adjust the overall length of the animal leash 10′ based on individual preferences and the needs of the animal.

The animal leash may be used to teach and or prohibit puppies as well as full grown dogs from certain behavior. Animal leash may make walking a dog much more enjoyable and easy due to added control in three-dimensions while still providing ample freedom of movement when desired. For example, the animal leash may help the user better prevent the dog from jumping or grabbing the leash out of the user's hands, which may aid in training the dog. Furthermore, the rigid nature of the animal leash prevents tangling within the user's legs or within the dogs's legs. Additionally, the rigid nature of the leash may be used in self-defense to provide added protection for the user and his or her dog if necessary. Although not shown, the animal leash can also be adapted to carry additional safety devices such as, for example but not limited to, a flashlight, cell phone, etc.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. An animal leash, comprising:
a rigid handle portion configured to be held by a hand of a user;
a rigid rod extending along a longitudinal axis and having a proximal end and a distal end, wherein the proximal end is rigidly connected to the handle portion; and
an attachment portion coupled at or near the distal end of the rigid rod and configured to be removeably attached to a collar or harness on an animal.

2. The animal leash according to claim 1, wherein the attachment portion is rotatably coupled to the distal end of the rigid rod.

3. The animal leash according to claim 2, wherein the attachment portion includes a swivel connection element rotatably coupled to the distal end of the rigid rod.

4. The animal leash according to claim 3, wherein the attachment portion includes a leash clip member coupled to the swivel connection element.

5. The animal leash according to claim 4, wherein the swivel connection element comprises an eye bolt, and wherein the attachment portion further includes an intermediate connector coupled between the eye bolt and the leash clip.

6. The animal leash according to claim 3, further comprising an end cap fixedly connected to the distal end of the rigid rod, wherein the swivel connection element is rotatably coupled to the end cap.

7. The animal leash according to claim 1, wherein the handle portion and the rigid rod are continuously rigid.

8. The animal leash according to claim 1, wherein the handle portion and the rigid rod are integrally formed from a rigid tubular member.

9. The animal leash according to claim 8, wherein the handle portion comprises a section bent relative to the longitudinal axis of the rigid rod.

10. The animal leash according to claim 1, further comprising a safety tether connected to an end of the handle portion and configured to be worn around a wrist of the user during use.

11. The animal leash according to claim 10, wherein the safety tether is connected to the end of the handle portion by a swivel connection element.

12. The animal leash according to claim 11, wherein the swivel connection element comprises an eye bolt rotatably coupled to the end of the handle portion.

13. The animal leash according to claim 1, wherein the rigid rod is extendable.

14. The animal leash according to claim 1, wherein a length of the rigid rod is between approximately 20 and 60 inches.

15. The animal leash according to claim 14, wherein the length of the rigid rod is between approximately 40 and 55 inches.

16. The animal leash according to claim 1, wherein the rigid rod and the handle are integrally formed from plastic or metal tubing.

17. The animal leash according to claim 16, wherein the plastic tubing comprises polyvinylchloride.

18. The animal leash according to claim 16, wherein the metal tubing comprises aluminum.

19. The animal leash according to claim 1, further comprising an extension assembly configured to be removeably coupled to the attachment portion to length the animal leash.

20. The animal leash according to claim 1, further comprising a yoke assembly configured to be removeably coupled to the attachment portion, wherein the yoke assembly includes a transverse crosspiece having first and second ends, and wherein first and second attachment portions are coupled are at or near the ends of the transverse crosspiece and each is configured to be removeably attached to the collar or harness on the animal.
